(19) United States
(12) Patent Application Publication
(10) Pub. No.: US 2025/0321090 A1
(43) Pub. Date: Oct. 16, 2025

(54) MEASURING SYSTEM AND METHOD FOR CHARACTERIZING A MULTILAYER STRUCTURE WITH LAYER-BY-LAYER DIFFERENT OHMIC PROPERTIES, SENSOR MODULE FOR A MEASURING SYSTEM, MANUFACTURING SYSTEM FOR A MULTILAYER STRUCTURE WITH LAYER-BY-LAYER DIFFERENT OHMIC PROPERTIES

(71) Applicant: Namisens GmbH, Bühl (DE)

(72) Inventor: Dominic CZEMPAS, Karlsruhe (DE)

(73) Assignee: Namisens GmbH, Bühl (DE)

(21) Appl. No.: 19/233,668

(22) Filed: Jun. 10, 2025

(30) Foreign Application Priority Data
Apr. 16, 2024 (DE) 102024110653
Mar. 10, 2025 (EP) 25162521.6

(51) Int. Cl. G01B 11/06; G01D 5/20; G01D 5/24

(52) U.S. Cl. CPC G01B 11/06; G01D 5/20; G01D 5/24

(57) ABSTRACT

A measuring system for characterizing a multilayered structure with layer-by-layer different ohmic properties, having a sensor module, an electrical switching device, and a measuring electronics unit. The sensor module has more than two planar coils arranged in a stack, and the electrical switching device is contacted with the planar coils and is configured to connect these coils to the measuring electronics unit such that the coils are switchable between a measuring configuration and a reference configuration. In the measuring configuration, the planar coils at least partially form an optionally inductive or capacitive measuring sensor, with the detection area extending outside the sensor module for determining a property of a low and/or high-resistance layer of the structure. In the reference configuration, the planar coils at least partially form an optionally inductive or capacitive reference sensor, with the detection area extending essentially inside the sensor module for determining a sensor module property.

### CROSS-REFERENCE TO RELATED APPLICATIONS

This application claims priority to European Patent Application No. 25162521.6, filed Mar. 10, 2025, and German Patent Application No. 10 2024 110 653.0, filed Apr. 16, 2024, both of which are incorporated herein by reference as if fully set forth.

### TECHNICAL FIELD

The invention relates to a measuring system and a method for characterizing a multilayer structure with layer-by-layer different ohmic properties. The invention also relates to a sensor module for a measuring system and a manufacturing system for producing a multilayer structure with layer-by-layer different ohmic properties.

### BACKGROUND

Multilayer structures having differing ohmic properties are used in various fields. In the automobile industry, for example, they can be provided as battery electrodes, in which in each case a metal layer, which is typically formed by a copper or aluminum foil, is provided with a graphite-containing layer. The metal layer has a lower ohmic resistance in this case than the graphite-containing layer. The metal layer can thus be viewed as a low-resistance layer and the graphite-containing layer as a high-resistance layer.

In order to enable a good functionality of the multilayer structure in the above example of the battery electrodes, it has to be ensured that in particular the above-mentioned components have the required properties. Quality assurance measures are necessary for this purpose, using which the mentioned properties can be determined and in order if necessary to subsequently adapt a process parameter of a manufacturing process in the production of the multilayer structure or to exclude a checked structure from further processing or delivery in case of inadequate quality. In particular, being able to perform the characterization of the multilayer structure not only at points, but ideally comprehensively, is desired. In this case, the properties of the high-resistance layer are particularly relevant, which is typically applied to the low-resistance layer and has to be provided here in a desired layer thickness and layer density.

Measuring systems based on x-ray technology offer one possibility to be able to perform nondestructive characterization of the multilayer structure. It is possible in this case depending on the radiographic behavior or refraction behavior of x-rays, which are applied to the multilayer structure, to conclude the layer properties. However, it is disadvantageous that such measuring systems are very technically complex and are susceptible to influences from the manufacturing environment.

Optical measuring systems offer another possibility, of which in particular those operating according to the confocal principle have become established in industrial metrology. Such optical measuring systems do have a high level of accuracy, however, only information at points is detectable using them about the surface of an optically visible layer of the structure to be characterized. It is possible to adjust such an optical measuring system by means of a manipulator in relation to the multilayer structure, such as a battery electrode. However, even in this case comprehensive checking of the structure is not possible in spite of the high technical expenditure, in particular if the structure to be characterized is in motion, as is typical, for example, during the coating of battery electrodes.

In addition, the multilayer structures can also have relevant properties, which are detectable neither by x-ray nor optically in principle. On the basis of the example of the battery electrode, this can involve the electrical properties of the high-resistance graphite-containing layer, which is supposed to move within the predetermined tolerance limits in particular after the so-called calendering process so that the desired quality of the multilayer structure can be achieved. The electrical properties are dependent in this case not only on the layer thickness, but rather moreover on the layer density.

In summary, the measuring systems coming into consideration for characterizing multilayer structures having different ohmic properties are either integratable only with a high expenditure in manufacturing processes or only offer inadequate information about the structure to be characterized. A high integration expenditure means at this point in particular that the above-mentioned measuring methods each have to be installed on two sides of the structure to be checked, for example thus above and below an electrode to be measured. In addition, the measuring systems coming into consideration are restricted in principle to measured variables which do not enable a comprehensive characterization of multilayer structures.

### SUMMARY

It is therefore the object of the invention to propose means for characterizing multilayer structures with different ohmic properties, which are accompanied by a permanently high accuracy, are integratable with low expenditure into the production of such structures, in particular battery electrodes, and enable a comprehensive conclusion about the layer properties.

The object is achieved by means of a measuring system having one or more of the features disclosed herein, a sensor module having one or more of the features disclosed herein, a manufacturing system having one or more of the features disclosed herein, and a method having one or more of the features disclosed herein. Advantageous refinements are the described below and in the claims.

The measuring system according to the invention is suitable for characterizing a multilayer structure with layer-by-layer different ohmic properties. In particular, the structure can be a battery electrode. The measuring system comprises a sensor module, an electrical switching device, and a measuring electronics unit. The sensor module comprises more than two planar coils, which are arranged in a coil stack. The electrical switching device is contacted with the planar coils and is configured to connect the planar coils to the measuring electronics unit such that the planar coils are switchable between at least one measuring configuration and one reference configuration. In the measuring configuration, the planar coils at least partially form an optionally inductive or capacitive measuring sensor, the detection area of which extends outside the sensor module to determine a property of a low-resistance and/or high-resistance layer of the structure. In the reference configuration, the planar coils at least partially form an optionally inductive or capacitive reference sensor, the detection area of which extends essentially inside the sensor module, in order to determine a sensor module property.

One finding on which the invention is based is that the use of planar coils, on the one hand, enables an electromagnetic sensor to be formed which can be operated both as an inductive and as a capacitive sensor, in order to be able to comprehensively characterize a multilayer structure with layer-by-layer different ohmic properties, wherein this sensor can be arranged on only one side of the structure. As is explained in more detail hereinafter, in particular a layer thickness of the high-resistance layer is ascertainable with high accuracy. Furthermore, the use of planar coils enables an action direction reversal of such an electromagnetic sensor, so that its inductive or capacitive active principle can also be used to ascertain a sensor module property. The accuracy in the ascertainment of the layer properties, in particular the layer thickness of the high-resistance layer, can thus be significantly increased if necessary.

In the scope of the invention, the planar coils can each be viewed as sensor elements having multiple turns, which each extend in a coil plane. These properties of a planar coil enable it to be made compact and flat, which makes it particularly suitable for applications in which the available installation space is limited. Furthermore, the planar coils are available comparatively inexpensively, so that in particular multiple sensor modules can be arranged in the manner of a sensor array in order to enable a comprehensive characterization of the structure. In particular, it is conceivable to arrange such a sensor array above a moving structure, in particular a battery electrode, and to design the sensor array as a line array, for example, which extends at a distance transversely to a movement direction of the moving structure. A comprehensive quality check of the structure can thus be performed contactlessly in the measuring configuration.

A coil stack can be viewed in the scope of the invention as a three-dimensional arrangement of planar coils, in which at least three planar coils are arranged parallel to one another with respect to the respective coil planes, in particular spaced apart from one another. In particular, planar coils are arranged here such that their respective turns or their extension areas overlap in a viewing direction orthogonal to the coil planes. In particular, the planar coils each have a center axis which extends essentially orthogonally to the respective coil plane. Preferably, the at least three planar coils are arranged coaxially to one another with respect to their center axis. In particular, the planar coils of the coil stack are embodied structurally identically.

The switching device can be viewed in the scope of the invention as an electrical and/or electronic component or an arrangement thereof, which is electrically contacted with the planar coils, in particular with the turn ends of the planar coils, and the measuring electronics unit and is configured to establish, disconnect, or change as needed a signaling and/or energetic connection between the measuring electronics unit and at least a part of the planar coils, in particular their turn ends. For example, the switching device can comprise an analog multiplexer and/or a field programmable analog array.

The measuring electronics unit can likewise be viewed in the scope of the invention as an electrical and/or electronic component or an arrangement thereof, which supplies the sensor module with electrical energy and/or signals, in particular so that a measuring sensor can thus be formed in the measuring configuration and a reference sensor can be formed in the reference configuration. Furthermore, the measuring electronics unit is used to process the electrical measured and reference variables detectable by means of the sensor module and to output a measurement result. In particular, the measuring electronics unit is configured to output a layer property, in particular the layer thickness of the high-resistance layer, or a measured variable dependent thereon.

The design of the planar coils and their arrangement in the coil stack enable the planar coils to be operated both in the measuring configuration and in the reference configuration as inductive sensor elements and/or as capacitive sensor elements. In particular, at least one of the planar coils can be designed as a shielding element in order to create an action direction reversal between the measuring configuration and the reference configuration if needed.

In particular, the switching device and the measuring electronics unit are designed as cooperating such that one or more planar coils of the sensor module can each be designed for the measuring configuration optionally as an inductive transmitting coil, inductive receiving coil, capacitive measuring electrode, or as a shielding element. Accordingly, the switching device and the measuring electronics unit are preferably designed such that one or more planar coils of the sensor module can each be designed for the reference configuration optionally as an inductive reference transmitting coil, inductive reference receiving coil, capacitive reference measuring electrode, or as a shielding element.

As mentioned above, in the measuring configuration, the sensor module forms a detection area which extends outside the sensor module. In particular, the detection area can be defined by a magnetic field and/or an electrical field. With a multilayer structure arranged in the detection area, the detection area is used to interact with the high-resistance and/or low-resistance layer of the structure. The planar coils can be contacted in this case with the measuring electronics unit by means of the switching device such that a part of the planar coils is supplied with electrical energy in order to be used as an active sensor element and another part of the planar coils is used as a passive sensor element in order to receive an inductive and/or capacitive measurement signal.

In the measuring configuration, in which the sensor module forms an inductive measuring sensor, the detection area is in particular provided so as to interact with the low-resistance layer of the structure, in particular a metallic layer of a battery electrode. In the measuring configuration, in which the sensor module forms a capacitive measuring sensor, the detection area is in particular provided so as to interact with the high-resistance layer of the structure.

As already mentioned above, the sensor module also forms a detection area in the reference configuration. This can also be defined by a magnetic field and/or an electrical field and essentially extends in the sensor module. In particular, in the reference configuration at least one of the planar coils is connected by means of the switching device to the measuring electronics unit such that it forms an electrical shield in relation to the sensor environment. In particular, in this case this can be an outer planar coil within the coil stack. The other planar coils can be contacted by means of the switching device with the measuring electronics unit such that a part of the planar coils is supplied with electrical energy in order to be used as an active sensor element, and another part of the planar coils is used as a passive sensor element in order to receive an inductive and/or capacitive reference measurement signal which enables a conclusion about a sensor module property.

The action direction reversal of the sensor module achievable according to the invention is surprising in particular with regard to the reference configuration in which the planar coils at least partially form a capacitive reference sensor. High-resistance sensor elements typically function as field conductors and corrupt capacitive measurement results. However, as studies of the applicant have shown, this negative effect is nearly negligible for a capacitive reference measurement due to the naturally flat structure of planar coils. It is thus possible, for example, to ascertain a distance between two outer planar coils of the coil stack on the basis of a capacitive reference measured variable. In this case, this is a sensor module property which can be taken into consideration in the ascertainment of the layer property.

One particular advantage is achievable using the invention if the sensor module is designed like a multilayer printed circuit board, in which the planar coils are each formed by a substantially flatly extending, spiral-shaped copper track, preferably having a thickness of at most 10 μm, and the planar coils are isolated from one another in pairs by means of an electrically insulating carrier material.

In the above-described advantageous refinement, the sensor module and its sensor elements are designed as components having a high degree of functional integration. This has the disadvantage that other components, such as temperature sensors, cannot be integrated into the sensor module without changing its compact design. At the same time, the carrier material is susceptible to temperature variations and moisture, due to which its dimensions and therefore also the relative arrangement of the planar coils in relation to one another changes. However, it is in particular possible by means of the above-described action direction reversal in the reference configuration to ascertain a relative location between at least two of the at least three planar coils in relation to one another and to take it into consideration for the evaluation of the measurement signals in the measuring configuration. In particular a sensor drift can thus be compensated, which can be caused by the above-mentioned temperature variations in moisture. The sensor drift can be viewed in this case as a systematic or random deviation of a measured variable in the measuring configuration. Therefore, no further sensors, in particular temperature sensors or moisture sensors, are necessary to enable a high accuracy of the measuring system.

In one advantageous refinement, a high-frequency AC voltage can be applied to at least one planar coil in the manner of a transmitting coil by means of the measuring electronics unit to form the inductive measuring sensor. At least one of the other planar coils, preferably two other planar coils, are each provided in the manner of a receiving coil to detect an inductive measured variable in interaction with the measuring electronics unit. The measuring electronics unit is configured to determine a distance between the sensor module and the low-resistance layer of the structure depending on the inductive measured variable.

In the measuring configuration, in which the sensor module forms an inductive measuring sensor, the functionality of an eddy current sensor can be utilized, in which an alternating magnetic field generated by means of a transmitting coil interacts with a low-resistance layer of the structure and this interaction or a change thereof is detectable by means of at least one receiving coil. In particular, the planar coil designed as a transmitting coil is arranged in a coil stack between at least two other planar coils, of which at least one, in particular both can be formed as receiving coils. The measuring electronics unit is configured to determine a distance between the sensor module and the low-resistance layer of the structure as a function of the inductive measured variable.

The inductive measurement signal can in this case be an AC voltage induced in the receiving coil or a difference between the AC voltages of two receiving coils. An amplitude of such an inductive measurement signal is, in particular at frequencies above 1 MHZ, dependent on the distance between the sensor module and the surface of the low-resistance layer, in particular a distance between the coil plane of the transmitting coil and the surface of the metallic substrate of a battery electrode. At low frequencies, the eddy currents penetrate the micrometer-thin metal layer of the electrode, wherein amplitudes and phase shifts dependent on electrode thicknesses result as interfering in this case. The flat structural form of planar coils enables in particular interfering thickness influences as a result of a frequency-dependent penetration of the alternating magnetic field into the low-resistance layer to be reduced, so that a high accuracy is achievable in the distance measurement. At the same time, the high-resistance layer, in particular a graphite-containing layer, generates no or only a negligibly small amount of eddy currents, so that it can be penetrated and has no influences here on the distance measurement in relation to the low-resistance layer.

In one advantageous refinement, to form the capacitive measuring sensor, a low-frequency AC voltage can be applied at least to a preferably outer planar coil of the coil stack in the manner of a measuring electrode by means of the measuring electronics unit, which outer planar coil is provided to detect a capacitive measured variable in cooperation with the measuring electronics unit. At least one planar coil adjacent to the measuring electrode is provided in the manner of a shielding electrode to shield the detection area in relation to the sensor module. The measuring electronics unit is configured to determine a distance between the sensor module and the high-resistance layer of the structure as a function of the capacitive measured variable.

In a measuring configuration in which the sensor module forms a capacitive measuring sensor, a planar coil is used as a capacitive measuring electrode, in particular in that only one turn end is connected by means of the switching device to the measuring electronics unit and the respective other turn end is switched to high resistance or is open. In this measuring configuration, an outer planar coil of the coil stack is expediently designed in the manner of a measuring electrode and is used to form an electrical field, which interacts with the high-resistance layer of the structure, in particular the graphite layer of the battery electrode. Another planar coil, in particular adjacent thereto, of the coil stack can form the shielding electrode in the above-mentioned manner, in particular in that it is likewise switched to another reference potential, in particular to ground, in relation to the potential of the measuring electrode at only one turn end.

The capacitive measurement signal can in a simple form be an AC voltage which is detectable by means of the measuring electronics unit, in particular by means of a measuring circuit of the measuring electronics unit, and which is dependent on the interaction of the electrical field with the high-resistance layer. An amplitude of such a capacitive measurement signal is, in particular at frequencies below 50 kHz, dependent on the distance between the sensor module and the surface of the high-resistance layer, in particular between the coil plane of the measuring electrode and the surface of a graphite-containing layer of a battery electrode.

In one advantageous refinement, the measuring electronics unit is configured to determine a layer thickness of the high-resistance layer as a function of the difference between the capacitive measured variable and the inductive measured variable.

The above-described advantageous refinement is based on the finding that the successive performance of an inductive and capacitive measurement in the measuring configuration enables an accurate determination of the layer thickness of the high-resistance layer. In particular, this is possible in that initially a distance between the sensor module and the surface of the low-resistance layer is concluded as a function of the inductive measured variable and then a distance between the sensor module and the surface of the high-resistance layer is concluded as a function of the inductive measured variable. The layer thickness of the high-resistance layer can then be ascertained by ascertaining a difference between the two distances.

It is within the scope of the invention that the switching device is configured to initially set the measuring configuration to form the inductive measuring sensor and then to form the capacitive measuring sensor or vice versa. The planar coils of the same sensor module can thus be operated as at least two types of measuring sensors, in order to characterize the multilayer structure with high accuracy.

In an advantageous refinement, to form the capacitive reference sensor, at least one preferably outer planar coil of the coil stack is provided in the manner of a shielding electrode for the purpose of shielding the detection area of the capacitive sensor in relation to a sensor environment. A low-frequency AC voltage can be applied to a planar coil adjacent thereto in the manner of a reference measuring electrode by means of the measuring electronics unit, which planar coil is intended to detect a capacitive reference measured variable in interaction with the measuring electronics unit. The measuring electronics unit is configured to determine a relative location between the reference measuring electrode and another planar coil of the coil stack as a function of the capacitive reference measured variable.

The above-described refinement relates to an aspect of the above-described action direction reversal. In that a planar coil, in particular an outer planar coil, is switched as a shielding electrode, another planar coil adjacent thereto can be used as an active sensor element in order to ascertain a sensor module property, in particular a distance in relation to another planar coil of the coil stack. This is particularly advantageous since the dimensions of the sensor module can vary as a result of temperature variations and moisture and this can have an effect on the accuracy in the measuring configuration. In a simple embodiment, the ascertained sensor module property is at least comparable to a limiting value in order to be able to ascertain whether the distance between two of its planar coils is in a tolerable state.

Preferably, for the reference configuration, in which the planar coils at least partially form a capacitive reference sensor, the same planar coils are connected to the measuring electronics unit as those which are used in the measuring configuration to form the measuring electrode and the shielding electrode. In contrast thereto, the functions of the mentioned planar coils are exchanged, however. In other words, the planar coil of the capacitive measuring sensor used as a measuring electrode functions as a shielding electrode of the capacitive reference sensor and the planar coil of the capacitive measuring sensor used as a shielding electrode functions as a reference measuring electrode of the capacitive reference sensor.

In a simple embodiment, the capacitive reference measurement signal can be an AC voltage, which is detectable by means of the measuring electronics unit, in particular by means of a measuring circuit of the measuring electronics unit, and which is dependent on the interaction of the electrical field, which can be generated by means of the reference measuring electrode, with one of the other planar coils.

The measuring electronics unit is preferably configured to ascertain a correction value as a function of the relative location between the reference measuring electrode and the other planar coil of the coil stack and to determine the layer thickness of the high-resistance layer as a function of the correction value.

The above-described advantageous refinement is not restricted to the way in which the correction value is taken into consideration in the determination of the layer thickness of the high-resistance layer. In a simple embodiment, a lookup table can be stored in the measuring electronics unit or the data processing unit connected thereto, which specifies the correction value as a function of the capacitive reference measured variable and can be offset indirectly or directly with the ascertained layer thickness. It is also within the scope of the advantageous refinement that additionally or alternatively to a lookup table, a mathematical model is stored, which specifies, for example, an analytical and/or numeric and/or statistical and/or experimental relationship between the correction value and the ascertained capacitive measured variable and by means of which in particular the layer thickness of the high-resistance layer is determinable.

In one advantageous refinement, to form an inductive reference sensor, at least one planar coil is short-circuited by means of the switching device of the coil stack and a high-frequency AC voltage can be applied to another planar coil by means of the measuring electronics unit in the manner of a reference transmitting coil. At least one planar coil located between the short-circuited planar coil and the reference transmitting coil is provided in the manner of a reference receiving coil to detect an inductive reference measured variable in cooperation with the measuring electronics unit. The measuring electronics unit is configured to determine a property of the interposed planar coil, in particular its functional capability, as a function of the inductive reference measured variable.

One advantage of the above-described refinement is that a self-check of the sensor module can be carried out in that one of the planar coils defines a test object by means of a short-circuit of its turn ends, which test object can interact with the alternating magnetic field of another planar coil used as a reference transmitting coil and in this case in particular eddy currents can be generated in the short-circuited planar coil. The interposed planar coil is used as a reference receiving coil and is used to detect such interactions. In particular if an amplitude and frequency of the AC voltage, using which the transmitting coil can be excited, are specified, it can be checked by means of the measuring electronics unit whether the inductive reference measured variable, in particular its amplitude and/or frequency, exceeds or falls below a predetermined limiting value. The functional capability of said interposed planar coil can thus be determined, for example.

In one advantageous refinement, the sensor module is mounted so it is adjustable along the stack axis. A distance-controlled actuator can be provided for this purpose, by means of which the sensor module is adjustably mounted. In particular in the measuring configuration, the detection area of the inductive and/or capacitive measuring sensor can be adjusted by an adjustment, by which a larger measuring range of the measuring system results overall.

In one advantageous refinement, the sensor module comprises more than three planar coils, which are arranged in the coil stack. In particular, these planar coils can be contacted with the measuring electronics unit by means of the switching device and if needed, as described above, form an inductive measuring sensor or a capacitive measuring sensor or an inductive reference measuring sensor or a capacitive reference measuring sensor. The same statements on the above-explained embodiment of the measuring system according to the invention or its advantageous refinements therefore apply accordingly.

One advantage which accompanies the design of a sensor module comprising more than three planar coils is related to the fact that the planar coils which are not configured as transmitting coil, receiving coil, measuring electrode, reference transmitting coil, reference receiving coil, reference measuring electrode can be used as shielding elements. This is advantageous in particular since in the reference configuration, the sensor module property can be ascertained in the presence of the structure to be characterized, in particular a battery electrode, without this influencing the reference measurement or vice versa.

In one conceivable embodiment, the sensor module in particular has five planar coils which are arranged in the coil stack.

In the measuring configuration in which the sensor module has five planar coils, to form an inductive measuring sensor, two outer planar coils can each be contacted in the manner of an electrical shield with the measuring electronics unit and the three remaining planar coils can be switched, in the above-described manner, as one transmitting coil and two receiving coils.

In the measuring configuration, in which the sensor module has five planar coils, to form a capacitive measuring sensor, two outer planar coils can each be contacted in the manner of a measuring electrode with the measuring electronics unit and at least their respective adjacent planar coils can each be contacted in the above-described way in the manner of an electrical shield with the measuring electronics unit.

In the reference configuration, in which the sensor module has four planar coils, to form the inductive reference sensor, one of the outer planar coils can be contacted in the manner of a reference transmitting coil with the measuring electronics unit and another outer planar coil can be short-circuited at the turn ends. The interposed planar coils can each form a reference receiver coil, which are in particular contacted in chronological succession with the measuring electronics unit, in order to detect an inductive reference measured variable in each case, so that in each case a property of the planar coils, preferably their functional capabilities, are ascertainable.

In the reference configuration, in which the sensor module has four planar coils, to form the capacitive reference sensor, two outer planar coils can each be contacted in the manner of an electrical shield with the measuring electronics unit and at least their respective adjacent planar coils can be contacted, in particular in chronological succession, as referenced measuring electrodes with the measuring electronics unit, in order to ascertain the distance to one another, in particular with averaging of two distances ascertained in chronological succession.

The switching device is preferably designed to contact a part of the planar coils from the coil stack with the measuring electronics unit to form the measuring sensor and/or to form the reference sensor. This is advantageous in particular if the sensor module comprises more than three planar coils, so that only some of them are used to form the respective sensors. In particular planar coils can thus be selected, due to which the detection area in the measuring configuration and/or the reference configuration can be adjusted if needed, in particular can be spatially moved along the stack axis.

Such a spatial adjustment of the detection area is advantageous in particular for the design of the inductive measuring sensor. This is because although the inductive measuring sensor having only three planar coils is fundamentally capable of forming a detection area having an extension of up to 10 mm parallel to the stack axis, its sensitivity is reduced with increasing distance from the sensor module. This can be counteracted by an amplification of the applied AC voltage at the transmitting coil, but in this way the signal-to-noise ratio of the inductive measured variable typically also changes. Therefore, the switching device can be configured to contact at least two different planar coils of the sensor module in the manner of a transmitting coil and at least one other planar coil in the manner of a receiving coil in chronological succession with the measuring electronics unit. As a result of the movement of the detection area thus achievable, the desired sensitivity can already be achieved at a distance of at least 10 μm between the two selected transmitting coils.

A comparable advantage can be achieved for the design of the capacitive measuring sensor. The switching device can be configured in this case to contact at least two different planar coil pairs of the sensor module in the manner of a measuring electrode and an electrical shield in chronological succession with the measuring electronics unit, by which the detection area is also adjustable along the stack axis.

The switching device is preferably configured to electrically connect at least two planar coils in series if needed. This is conceivable in particular if more than three planar coils are arranged in the coil stack. One advantage which results is that the number of turns of a planar coil can be expanded by the number of turns of at least one other planar coil. It is possible in particular in this way to set in steps the total number of turns of a transmitting coil and/or receiving coil of an inductive measuring sensor and/or a reference transmitting coil and/or reference receiving coil of an inductive reference sensor.

It is advantageous if the switching device is designed to form two inductive measuring sensors in the measuring configuration in chronological succession, each of which comprises at least one transmitting coil, the total number of turns of which differs. This embodiment of the measuring configuration is based on the finding that low numbers of turns of a planar coil are advantageous to generate a high-frequency alternating magnetic field. While frequencies above 1 MHz are advantageous in order to ascertain the distance between the sensor module and the surface of the low-resistance layer in the above-described manner, other properties can be ascertained below 1 MHz with a comparatively higher number of turns, in particular those which are first detectable as a result of a higher penetration depth of the alternating magnetic field. It is also conceivable that at least two planar coils are connected in series in order to form a receiving coil.

In particular, it is conceivable that the switching device is configured to electrically connect in series at least two planar coils of the coil stack, which are separated from one another by at least one other planar coil. Advantages result therefrom in particular if the two planar coils connected in series are contacted as a contiguous receiving coil with the measuring electronics unit and the at least one interposed other planar coil is to be used as a transmitting coil of an inductive measuring sensor. A parasitic capacitance of the planar coils connected in series can thus be reduced to a tolerable minimum and the resonance frequency can be changed as needed.

In a sensor module having more than three planar coils, the switching device is preferably configured to switch at least a part of the planar coils in an advantageous sequence. The sequence is determined in this case according to the position of the planar coils to be switched in the coil stack, wherein in particular a first group of planar coils and a second group of planar coils are separated from one another by at least one planar coil. The planar coils of the first and second group can be arranged symmetrically in this case in relation to the interposed planar coil of the coil stack and are connected such that the planar coils of the same position in the first and second group are connected in series to form coil pairs and these coil pairs are likewise connected to one another in series. Studies have shown that parasitic capacitances can be effectively reduced in this way.

In one advantageous refinement, to form the capacitive measuring sensor, an AC voltage can be applied to a preferably outer planar coil of the coil stack in two low-frequency ranges in the manner of a measuring electrode by means of the measuring electronics unit. This planar coil is provided in cooperation with the measuring electronics unit to detect a first capacitive measured variable in a first low-frequency range and to detect a second capacitive measured variable in the second low-frequency range. The measuring electronics unit is configured to determine a sheet resistance of the high-resistance layer as a function of an amplitude of the first measured variable and a phasing of the second measured variable. A planar coil adjacent thereto can expediently be used as a shielding electrode.

The above-described refinement is based on the finding of the applicant that it is possible by means of the measuring system according to the invention to also conclude further layer properties in addition to the layer thickness of the high-resistance layer. These include in particular the ascertainment of the sheet resistance of the high-resistance layer, since this permits a conclusion regarding its moisture and density.

The latter are relevant especially on the basis of the example of the battery electrode, since its production comprises a quality-relevant drying step and calendering, after which the moisture or density have to be provided as desired.

The ability to ascertain the moisture and the density of the high-resistance layer is based on the fact that these are in interaction with the ohmic properties of the high-resistance layer and are ascertainable at various frequencies. In particular, at relatively low frequencies, the resistive change of the high-resistance layer has a negligible influence on the phase of a capacitive measured variable. The distance between the sensor module and the surface of the high-resistance layer can be ascertained in this way. At comparatively higher frequencies, in particular above 500 kHz, however, the phase changes as a function of the ohmic resistance, by which this can be ascertained. In consideration of the layer thickness, which is ascertainable in the above-described manner as a function of the inductive measured variable, the sheet resistance can be ascertained.

For the purpose of distinguishing concepts, the frequencies of the first and second low-frequency range are both below a high-frequency range which is also mentioned above. In particular, a high-frequency range is above approximately 1 MHz.

As mentioned above, the object of the invention is also achieved by a sensor module as disclosed herein. The sensor module according to the invention is suitable to be used with a measuring system according to the invention or one of its advantageous refinements and comprises at least three planar coils arranged in a coil stack. The statements on the measuring system according to the invention and its advantageous refinements apply accordingly with respect to the advantages thus achievable and possible embodiments of the sensor module.

As also mentioned, the object of the invention is also achieved by a manufacturing system for a multilayer structure with layer-by-layer different ohmic properties having a measuring system according to the invention or an advantageous refinement thereof.

In particular, this is a manufacturing system for a battery electrode, which can comprise a low-resistance metallic layer and a high-resistance graphite layer applied thereon. Such a manufacturing system can comprise, for example, conveyor rollers or a comparable conveyor means, by means of which the low-resistance layer is conveyed and provided with the high-resistance layer at the same time. The sensor module of the measuring system is arranged in this case such that the structure to be characterized at least partially enters its detection area. The measuring system preferably comprises multiple sensor modules, which are arranged like a sensor array. The sensor modules are preferably arranged as a line array, which extends essentially transversely to the conveying axis of the structure. Otherwise, the statements on the measuring system according to the invention and its advantageous refinements apply accordingly.

If the manufacturing system is used to produce a battery electrode, it is advantageous if at least one sensor module is arranged after a calender and/or after a drying device with respect to the conveying direction of the battery electrode.

The object of the invention is also achieved by a method for characterizing a multilayer structure with layer-by-layer different ohmic properties comprising the following method steps:
A) providing a sensor module, a switching device, and a measuring electronics unit, wherein the sensor module comprises more than two planar coils arranged in a coil stack and wherein the electrical switching device is contacted with the planar coils and is configured to connect the planar coils to the measuring electronics unit;
B) actuating the switching device so that the planar coils are brought into a measuring configuration, wherein the planar coils at least partially form an inductive and/or capacitive measuring sensor, the detection area of which extends essentially outside the sensor module and a property of a low-resistance and/or high-resistance layer of the structure is detected here;
C) actuating the switching device so that the planar coils are brought into a reference configuration, wherein the planar coils at least partially form a capacitive and/or inductive reference sensor, the detection area of which extends essentially inside the sensor and a property of the sensor module is detected here.

The method according to the invention is preferably carried out using a measuring system according to the invention or an advantageous refinement thereof. In particular, the measuring system according to the invention or an advantageous refinement thereof is suitable for carrying out the method according to the invention. The statements on the measuring system according to the invention and its advantageous refinements apply accordingly with respect to the advantages achievable by the method and its possible embodiments.

### BRIEF DESCRIPTION OF THE DRAWINGS

Advantages of the invention are explained hereinafter on the basis of exemplary embodiments and the figures.

In the figures

FIGS. 1A-1B show a schematic side view of a first measuring system for characterizing a multilayer structure with five planar coils (FIG. 1A), and a schematic top view of a planar coil (FIG. 1B);

FIGS. 2A-2B show a schematic representation of a measuring configuration in which the sensor module of the measuring system forms an inductive measuring sensor (FIG. 2A), and a schematic representation of a measuring configuration in which the sensor module of the measuring system forms a capacitive measuring sensor (FIG. 2B);

FIGS. 3A-3B show a schematic representation of a reference configuration, in which the sensor module of the measuring system forms an inductive reference sensor and a schematic representation (FIG. 3A), and schematic representation of a measuring configuration, in which the sensor module of the measuring system forms a capacitive reference sensor (FIG. 3B);

FIG. 4 shows a schematic side view of a second measuring system; and

FIGS. 5A-5C show a schematic side view of the sensor module of the second measuring system for ascertaining a sheet resistance (FIG. 5A), measured variable courses in Cartesian coordinates (FIG. 5B), and as a pointer diagram (FIG. 5C).

### DETAILED DESCRIPTION

Battery electrodes typically represent structures with layer-by-layer different ohmic properties. In this case, a metallic component, which is used as a current collector, is typically provided as a copper or aluminum foil and is superficially provided with a graphite layer. The metallic component typically has a higher electrical conductivity here than the graphite layer having a comparatively lower electrical conductivity. In relation to one another, these are therefore a low-resistance layer and a high-resistance layer of the battery electrode.

The quality of the battery electrode is highly relevant for the quality of the battery cell in which it is used, wherein in particular the electrical properties play an important role. These are related in particular to the properties of the high-resistance layer. Means are explained hereinafter, using which in particular the layer thickness and further properties of the high-resistance layer can be ascertained with high accuracy and with a low integration effort during their production.

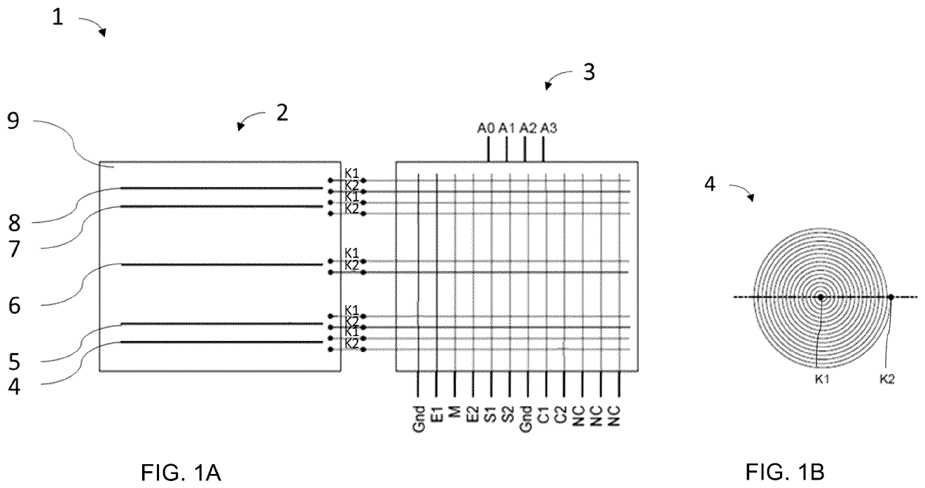

FIG. 1A shows a measuring system 1, which comprises a sensor module 2, an electrical switching device 3, and a measuring electronics unit (not shown).

The sensor module 2 is designed as a printed circuit board (PCB), in which five planar coils 4, 5, 6, 7, 8 are arranged in a coil stack and define the sensor elements of the sensor module 2. The planar coils 4, 5, 6, 7, 8 are each provided as an essentially flatly extending spiral-shaped copper track and are separated from one another 9 in pairs by means of an electrically insulating carrier material. A top view of such a planar coil 4, 5, 6, 7, 8 is shown by way of example on the basis of planar coil 4 in FIG. 1B. The planar coils 4, 5, 6, 7, 8 are essentially structurally identical and are provided concentrically in relation to a common stack axis, which lies in the plane of the image according to FIG. 1A.

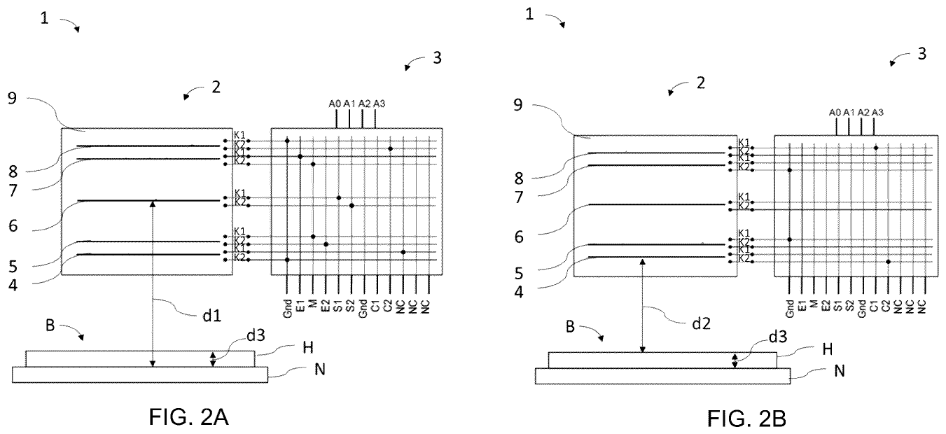

The planar coils 4, 5, 6, 7, 8 each have two turn ends K1 and K2, via which they are each electrically contacted with the switching device 3. The switching device 3 is designed in the exemplary embodiment shown in FIG. 1 as a field programmable analog array. In this case, this is an integrated circuit which enables processing of analog signals with a compact design. Control signals can be input for this purpose via the control inputs A0, A1, A2, A3, in dependence on which the analog inputs, which are contacted in the exemplary embodiment shown here with the respective turn ends K1, K2 of the planar coils 4, 5, 6, 7, 8, can be connected to one another as needed and can be switched through at the analog outputs Gnd, E1, M, E2, S1, S2, Gnd, C1, C2, NC, NC, NC, to which the measuring electronics unit (not shown) is connected. This will be explained on the basis of examples in FIGS. 2A to 5C for better comprehensibility.

It is relevant that the switching device 3 is configured to switch at least a part of the planar coils 4, 5, 6, 7, 8 between at least one measuring configuration and a reference configuration. In the measuring configuration, the planar coils 4, 5, 6, 7, 8 at least partially form an inductive or capacitive measuring sensor, the detection area of which extends outside the sensor module 2. A property of a low-resistance layer N or a high-resistance H of a structure to be characterized, for example, a battery electrode B, can thus be determined. In the reference configuration, at least three of the planar coils 4, 5, 6, 7, 8 form an inductive and/or capacitive reference sensor, the detection area of which extends essentially inside the sensor module in order to determine a sensor module property.

Although the sensor module 2 shown in FIG. 1A comprises five planar coils 4, 5, 6, 7, 8, it would be sufficient to implement the measuring configuration and the reference configuration if only three planar coils were provided, for example, the planar coils 5, 6, 7 in the coil stack. Advantageous functions can advantageously be depicted in the mentioned configurations using more than three planar coils, which will be explained by way of example hereinafter.

According to FIG. 2A, the switching device 3 is set to contact the planar coils 4, 5, 6, 7, 8 with the measuring electronics unit for a measuring configuration, so that the planar coils 4, 5, 6, 7, 8 form an inductive measuring sensor. In this case, the planar coil 6 is contacted in the manner of a transmitting coil at its turn ends K1, K2 with the connections S1 and S2, via which the measuring electronics unit can apply a high-frequency AC voltage above 1 MHz to the planar coil 6. The planar coils 5 and 7 are each contacted in the manner of a receiving coil with their respective turn ends K1, K2 with the connections M or E2 and M or E1, via which the measuring electronics unit can detect an inductive measured variable.

As a result of the high-frequency AC voltage, the planar coil 6 used as a transmitting coil generates an alternating magnetic field, which induces eddy currents in the low-resistance layer N of a battery electrode B. An interaction between the alternating magnetic field and the eddy currents is detectable by the planar coils 7 and 8 used as receiving coils and the measuring electronics unit. The inductive measured variable can in a simple case be a measurable AC voltage or a variable dependent thereon in this case, the amplitude of which indirectly indicates the distance d1 between the sensor module 1, in particular the planar coil 6, and the surface of the low-resistance layer N. The high-resistance layer H does not form eddy currents, so that they do not influence the inductive measured variable.

The planar coils 4, 8 in the exemplary embodiment shown here are contacted at their respective turn ends K1, K2, on the one hand, to a reference potential Gnd of the measuring electronics unit and switched with high resistance at the connections C2 and NC of the measuring electronics unit, so that they also have a negligible influence on the inductive measured variable. Alternatively, the turn ends of the planar coils 4 and 9 could also be open instead of the connections C2 or NC in order to achieve a comparable effect.

According to FIG. 2B, the switching device 3 is set so as to contact the planar coils 4, 5, 6, 7, 8 for a measuring configuration with the measuring electronics unit such that a part of the planar coils 4, 5, 6, 7, 8 forms a capacitive measuring sensor. In this case, the planar coil 4 is contacted like a measuring electrode with one of its turn ends K2 at the connections C2 and is open with the other turn end K2. By applying a low-frequency AC voltage in relation to its surroundings, in particular below 50 kHz, the planar coil 4 forms a capacitive sensor element. An alternating field thus formed interacts with the high-resistance layer H, thus the graphite layer of the battery electrode B. This can be ascertained by the measuring electronics unit at connection C2 as a capacitive measured variable, which can in particular likewise be present as a measurable AC voltage or variable dependent thereon, the amplitude of which indirectly indicates the distance d2 between the sensor module 1, in particular the planar coil 4, and the surface of the high-resistance layer H.

The planar coil 5 which is adjacent in the coil stack to the planar coil 4 is used as an electrical shield in relation to the sensor module 2, so that the other planar coils 6, 7, 8 and other sensor components have no or at least uniform influence on the capacitive measured variable. For this purpose, the planar coil 5 is contacted at one turn end K1 at a reference potential Gnd of the measuring electronics unit and the other turn end K2 is open.

The distances d1 and d2 can be determined at the same battery electrode by chronologically successive configuration of the inductive measuring sensor according to FIG. 1A and the capacitive measuring sensor according to FIG. 1B. At least if the relative location of the planar coils 4, 5, 6, 7, 8 is known, a thickness d3 of the high-resistance layer can be concluded by subtraction between the distances d1 and d2.

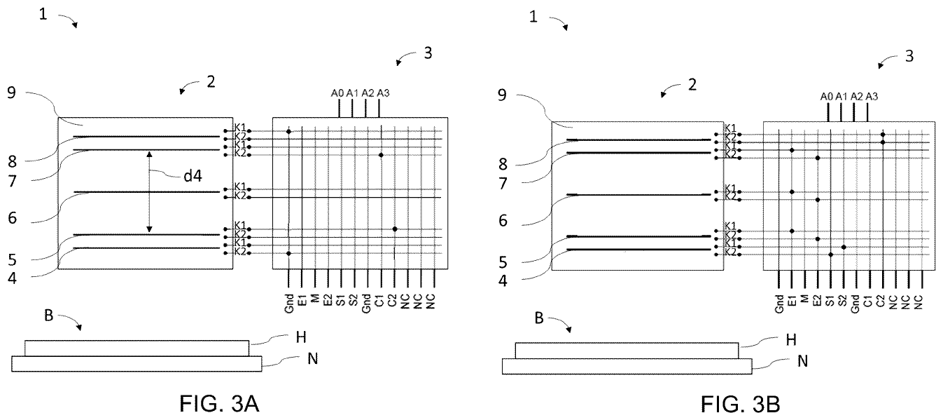

In view FIG. 3A, a reference configuration of the measuring system 1 is shown, in which the switching device 3 is set so as to contact the planar coils 4, 5, 6, 7, 8 with the measuring electronics unit such that a capacitive reference sensor is formed. Is thus at least possible to determine a distance between the planar coils 5 and 7.

The capacitive reference sensor according to FIG. 3A is formed in that the outer planar coils 4 and 8 are connected to the measuring electronics unit like an electrical shield. For this purpose, in each case one turn end is applied at the reference potential Gnd of the measuring electronics unit, while the respective other turn end is open. The planar coils 5 and 7 adjacent thereto are used as reference measuring coils, by means of which a distance d4 in relation to one another can be ascertained in chronological succession. For this purpose, initially one of the planar coils 5 and 7 can be formed via the connection C2 or C1 as a reference measuring electrode, by means of which an electrical field is generated that extends essentially inside the sensor module 2. Via the interaction of this alternating electrical field with the respective other planar coil 7 or 5, the distance d4 can be concluded via a measurable capacitive reference measured variable.

Such a reference measurement is advantageous, since a relative location of the planar coils 5 and 7 can be ascertained with the distance d4 and thus also the positions of the other planar coils 4, 6, 8 can be at least approximately ascertained, in particular if the sensor module 2 is formed symmetrically with respect to the positions of its planar coils 4, 5, 6, 7, 8.

It is an advantage that the capacitive reference measurement can be carried out in the presence of the battery electrode B to be characterized, without this having an interfering influence on the result of the capacitive reference measurement.

A reference configuration of the measuring system 1 is shown in FIG. 3B, in which the switching device 3 is set so as to contact the planar coils 4, 5, 6, 7, 8 with the measuring electronics unit such that an inductive reference sensor is formed. It is thus at least possible to determine a functional capability of the planar coils 5, 6, and 7.

The inductive reference sensor according to FIG. 3B is formed in that planar coil 9 is short-circuited by means of the switching device of the coil stack and a high-frequency AC voltage is applied to the planar coil 4 by means of the measuring electronics unit in the manner of a reference transmitting coil. The planar coils 5, 6, 7 located between the short-circuited planar coil 9 and the reference transmitting coil 4 are each provided in the manner of a reference receiving coil in order to detect an inductive reference measured variable in interaction with the measuring electronics unit. For this purpose, the planar coils 5, 6, 7 are connected in chronological succession at their respective turn ends K1, K2 to the connections E1 or E2. Their functional capability can be concluded depending on the induced voltages in the planar coils 5, 6, 7.

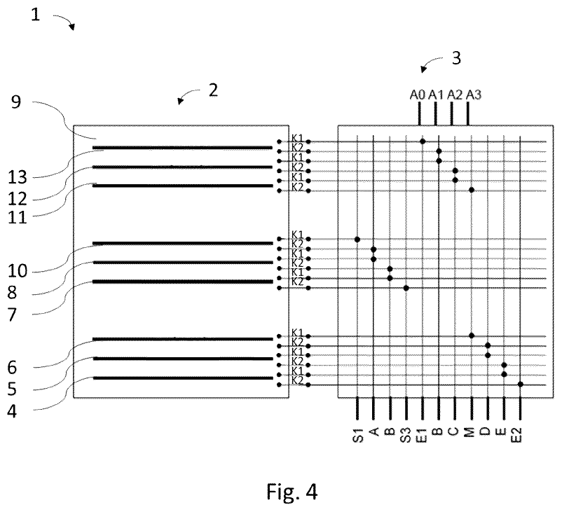

FIG. 4 shows a second measuring system 1, which comprises a sensor module 2, a switching device 3, and a measuring electronics unit (not shown). As explained with reference to FIGS. 1A to 3b, the sensor module 1 is formed in the manner of a printed circuit board. As explained with reference to the embodiments according to FIGS. 1A to 3B, it is likewise possible by means of the second measuring system 1 according to FIG. 4 to configure a measuring configuration and a reference configuration, so that essentially the same statements apply. However, as can be seen with reference to FIG. 4, the sensor module 2 comprises more than five planar coils, which are arranged in a carrier material 9.

By means of the switching device 3, it is possible to contact a part or all of the planar coils 4, 5, 6, 7, 8, 10, 11, 12, 13 from the coil stack with the measuring electronics unit to form a measuring sensor or reference sensor. In this case, it is possible, for example, to select individual planar coils 4, 5, 6, 7, 8, 10, 11, 12, 13 from the coil stack and to use only these to form the measuring sensor or the reference sensor or rather to connect them in series in order to influence the sensor module properties.

In the example shown in FIG. 4, the planar coils 4, 5, 6 can be connected in series by means of the switching device 3 and can be contacted with connection S1 via the turn end K1 of the planar coil 6 and with the measuring electronics unit via the turn end K2 of the planar coil 4. By application to the series circuit of the planar coils 4, 5, 6, an alternating magnetic field can be generated in the above-described manner, which can be in a different frequency range, however, due to the increased number of turns, for example, than in the measuring system 1 according to FIGS. 1A to 3C. Accordingly, the planar coils 4, 5, 6, 11, 12, 13 can be connected in series in order to function in the manner of a receiving coil of an inductive measuring sensor.

In a way not shown here, the switching device can be configured to contact at least two different planar coils of the sensor module in the manner of a transmitting coil and at least one other planar coil in the manner of a receiving coil with the measuring electronics unit in chronological succession. As a result of the movement of the detection area thus achievable, the sensitivity of such a measuring sensor can be sent to a desired sensitivity range. A comparable advantage can be achieved for the design of the capacitive measuring sensor. The switching device can be configured in this case to contact at least two different planar coil pairs of the sensor module in the manner of a measuring electrode and an electrical shield with the measuring electronics unit in chronological succession.

Alternatively to the interconnection shown in FIG. 4, it can furthermore be advantageous if the planar coils 4, 5, 6, 11, 12, 13 are connected in series in order to reduce parasitic capacitances of the sensor module. In particular, it is advantageous if the planar coils are interconnected in pairs, so that at least one other planar coil is arranged between the planar coils of a planar coil pair connected in series. With reference to the example shown in FIG. 4, a series circuit is conceivable in which the planar coils are connected in series in the sequence 4, 13, 5, 12, 6, 11 and in each case one turn end of the planar coils 4 and 11 is contacted with the measuring electronics unit to detect the inductive measured variable.

In addition, the sensor module shown in FIG. 4 can also be interconnected so that AC voltage is applied to an outer planar coil of the coil stack in two low-frequency ranges by means of the measuring electronics unit in the manner of a measuring electrode. In a first low-frequency range, a first capacitive measured variable can hereby be detected in the above-described manner, using which, as already described, a distance between the sensor module, in particular the planar coil used as the measuring electrode, and the high-resistance layer can be ascertained. In the second low-frequency range, which covers higher frequencies than the first low-frequency range, a second capacitive measured variable can be detected.

Studies of the applicant have shown that the first capacitive measured variable in the first low-frequency range has an amplitude which is dependent on the distance between the sensor module and the surface of the high-resistance layer and its phase is independent of the ohmic properties of the high-resistance layer. In contrast thereto, the second capacitive measured variable has a phase in the comparatively higher second low-frequency range which is dependent on the ohmic properties of the high-resistance layer. It is a finding that in consideration of the phase of the second capacitive measured variable, a sheet resistance of the high-resistance layer can be concluded.

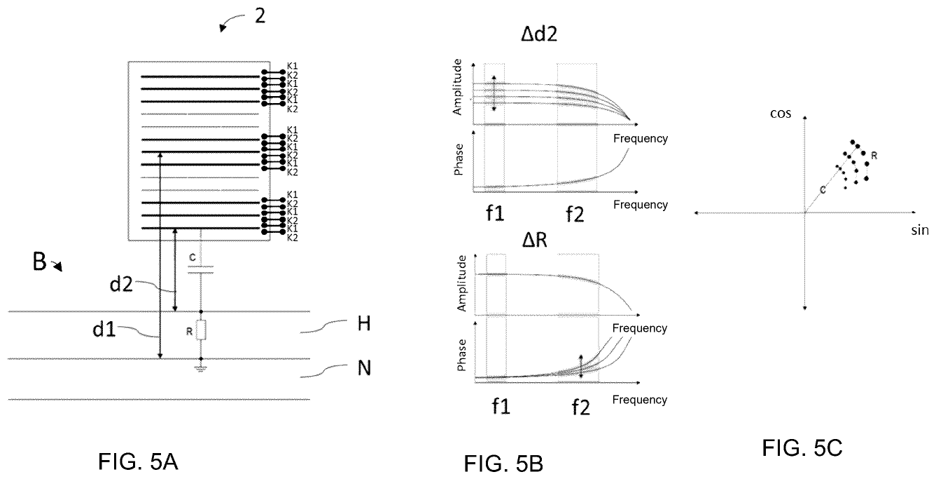

It is illustrated as a model on the basis of FIG. 5A that initially an inductive measured variable can be ascertained to ascertain a distance d1 between the sensor module 2 and the surface of the low-resistance layer N. Two capacitive measured variables can then be ascertained in two different low-frequency ranges in order to conclude the sheet resistance of the high-resistance layer.

FIG. 5B shows the courses of the amplitude and phase as a function of the frequency when the distance d2 between the sensor module varies (upper diagram Δd2) and when the ohmic properties of the high-resistance layer vary (lower diagram ΔR). It can be seen on the basis of the amplitude course in diagram Δd2 that it is dependent on the distance d2 in the first low-frequency range f1. In comparison thereto, it can be seen on the basis of the phase course in diagram AR that a change of the ohmic properties in the second low-frequency range results in a change of the phase of the capacitive measurement signal. FIG. 5C illustrates the substantive matter shown in FIG. 5B in a pointer diagram.

1. A measuring system (1) for characterizing a multilayered structure with layer-by-layer different ohmic properties, the system comprising:
a sensor module (2);
an electrical switching device (3);
a measuring electronics unit;
wherein the sensor module (2) comprises more than two planar coils (4, 5, 6, 7, 8), which are arranged in a coil stack and the electrical switching device (3) is contacted with the planar coils (4, 5, 6, 7, 8) and is configured to connect the planar coils (4, 5, 6, 7, 8) to the measuring electronics unit such that the planar coils (4, 5, 6, 7, 8) are switchable between at least one measuring configuration and one reference configuration,
in the measuring configuration, the planar coils (4, 5, 6, 7, 8) at least partially form a measuring sensor, a detection area of which extends outside the sensor module (2) in order to determine a property of a low-resistance layer (N) and/or a high-resistance layer (H) of the multilayered structure, and
in the reference configuration, the planar coils (4, 5, 6, 7, 8) at least partially form a reference sensor, the detection area of which extends essentially inside the sensor module (2) in order to determine a sensor module property.

2. The measuring system (1) of claim 1, wherein the measuring sensor is inductive or capacitive, and the reference sensor is inductive or capacitive.

3. The measuring system (1) as claimed in claim 2, wherein
application of a high-frequency AC voltage to at least one of the planar coils (4, 5, 6, 7, 8) acting as a transmitting coil by the measuring electronics forms the measuring sensor as an inductive measuring sensor,
and at least one of the other planar coils (4, 5, 6, 7, 8) acts as a receiving coil in order to detect an inductive measured variable in cooperation with the measuring electronics unit, and
the measuring electronics unit is configured to determine a distance (d1) between the sensor module (2) and the low-resistance layer (N) as a function of the inductive measured variable.

4. The measuring system (1) as claimed in claim 2, wherein
application of a low-frequency AC voltage to at least one planar coil (4, 5, 6, 7, 8) of the coil stack acting as a measuring electrode by the measuring electronics unit forms the measuring sensor as the capacitive measuring sensor and said coil is adapted to detect a capacitive measured variable in cooperation with the measuring electronics unit and
at least one adjacent planar coil (4, 5, 6, 7, 8) acts as a shielding electrode to shield the detection area in relation to the sensor module (2), and
the measuring electronics unit is configured to determine a distance (d2) between the sensor module (2) and the high-resistance layer (H) of the structure as a function of the capacitive measured variable.

5. The measuring system (1) as claimed in claim 3, wherein
application of a low-frequency AC voltage to at least one planar coil (4, 5, 6, 7, 8) of the coil stack acting as a measuring electrode by the measuring electronics unit forms the measuring sensor as the capacitive measuring sensor and said coil is adapted to detect a capacitive measured variable in cooperation with the measuring electronics unit and
at least one adjacent planar coil (4, 5, 6, 7, 8) acts as a shielding electrode to shield the detection area in relation to the sensor module (2), and
the measuring electronics unit is configured to determine a distance (d2) between the sensor module (2) and the high-resistance layer (H) of the structure as a function of the capacitive measured variable; and
the measuring electronics unit is configured to determine a layer thickness (d3) of the high-resistance layer as a function of the difference between the capacitive measured variable and the inductive measured variable and the respective distances (d1 and d2) derived therefrom.

6. The measuring system (1) as claimed in claim 5, wherein
to form the capacitive reference sensor, at least one planar coil (4, 5, 6, 7, 8) of the coil stack acts as a shielding electrode to shield the detection area of the capacitve measuring sensor in relation to the sensor surroundings, and
application of a low-frequency AC voltage to one of the planar coils (4, 5, 6, 7, 8) adjacent thereto acting as a reference measuring electrode by the measuring electronics unit is adapted to allow detection of a capacitive reference measured variable in cooperation with the measuring electronics unit,
and the measuring electronics unit is configured to determine a relative location between the reference measuring electrode and another one of the planar coils (4, 5, 6, 7, 8) of the coil stack as a function of the capacitive reference measured variable.

7. The measuring system (1) as claimed in claim 6, wherein
the measuring electronics unit is configured to ascertain a correction value as a function of a relative location between the reference measuring electrode and the other planar coil of the coil stack and to determine the layer thickness (d3) of the high-resistance layer (H) as a function of the correction value.

8. The measuring system (1) as claimed in claim 1, wherein
short-circuiting at least one of the planar coils (4, 5, 6, 7, 8) by the switching device (2) of the coil stack forms an inductive reference sensor,
and application of a high-frequency AC voltage to, another one of the planar coils (4, 5, 6, 7, 8) by the measuring electronics unit causes said planar coil to act as a reference transmitting coil, and
at least one of the planar coils (4, 5, 6, 7, 8) located between the short-circuited planar coil (4, 5, 6, 7, 8) and the reference transmitting coil (4, 5, 6, 7, 8) acts as a reference receiving coil to detect an inductive reference measured variable in cooperation with the measuring electronics unit,
and the measuring electronics unit is configured to determine a property of the interposed planar coil (4, 5, 6, 7, 8) as a function of the inductive reference measured variable.

9. The measuring system (1) as claimed in claim 1, wherein
the sensor module (2) is adjustably mounted ro be movable along a stack axis.

10. The measuring system (1) as claimed in claim 1, wherein
the sensor module (2) comprises more than of the three planar coils (4, 5, 6, 7, 8), which are arranged in the coil stack, and the switching device (2) is designed to contact at least a part of the planar coils (4, 5, 6, 7, 8) from the coil stack with the measuring electronics unit to form the measuring sensor and/or to form the reference sensor.

11. The measuring system (1) as claimed in claim 1, wherein
the switching device (2) is configured to electrically connect at least two of the planar coils (4, 5, 6, 7, 8) of the coil stack in series.

12. The measuring system (1) as claimed in claim 1, wherein the at least two planar coils that are connected in series are separated from one another by at least one other planar coil.

13. The measuring system (1) as claimed in claim 1, wherein
the switching device comprises an analog multiplexer and/or a field programmable analog array.

14. The measuring system (1) as claimed in claim 1, wherein
the sensor module (2) comprises a multilayer printed circuit board, in which the planar coils (4, 5, 6, 7, 8) are each formed by an essentially flatly extending, spiral-shaped copper track, and the planar coils (4,5, 6, 7, 8) are separated from one another in pairs by an electrically insulating carrier material (9).

15. The measuring system (1) as claimed in claim 1, wherein the spiral-shaped copper track forming each of the coils has a thickness of at most 10 μm.

16. The measuring system (1) as claimed in claim 2, wherein
application of AC voltage to one of the planar coil (4, 5, 6, 7, 8) of the coil stack acting as a measuring electrode by the measuring electronics unit in two different low-frequency ranges (f1, f2) forms the measuring sensor as the capacitive measuring sensor
and said coil is provided, in cooperation with the measuring electronics unit, is adapted to detect a first capacitive measured variable in a first low-frequency range (f1) and to detect a second capacitive measured variable in a second low-frequency range (f2), and wherein
the measuring electronics unit is configured to determine a sheet resistance of the high-resistance layer (H) as a function of an amplitude of the first measured variable and a phase of the second measured variable.

17. The measuring system (1) as claimed in claim 16, wherein the measuring electronics unit is configured to determine a moisture and/or density of the high-resistance layer (H).

18. A sensor module (2) for measuring system as claimed in claim 1, comprising more than two of the planar coils (4, 5, 6, 7, 8) arranged in the coil stack.

19. A manufacturing system for a multilayered structure with layer-by-layer different ohmic properties, comprising the measuring system (1) as claimed in claim 1.

20. A method for characterizing a multilayered structure with layer-by-layer different ohmic properties comprising the steps of:
A) providing a sensor module (2), a switching device (3), and a measuring electronics unit, wherein the sensor module (2) comprises more than two planar coils, which are arranged in a coil stack, and the electrical switching device (3) is contacted with the planar coils and is configured to connect the planar coils to the measuring electronics unit;
B) actuating the switching device (3), so that the planar coils are brought into a measuring configuration, wherein the three of the planar coils (4, 5, 6, 7, 8) form an inductive and/or capacitive measuring sensor, a detection area of which extends essentially outside the sensor module and detects a property of a low-resistance and/or high-resistance layer of the structure; and
C) actuating the switching device (3), so that the planar coils are brought into a reference configuration, wherein the three planar coils form a capacitive and/or inductive reference sensor, the detection area of which extends essentially inside the sensor module and detects a property of the sensor module.
